(19) United States
(12) Patent Application Publication
(10) Pub. No.: US 2013/0074051 A1
(43) Pub. Date: Mar. 21, 2013

(54) TRACKING AND ANALYSIS OF USAGE OF A SOFTWARE PRODUCT

(71) Applicant: Clinton Freeman, Annrrlloy (AU)

(72) Inventor: Clinton Freeman, Annrrlloy (AU)

(73) Assignee: NATIONAL ICT AUSTRALIA LIMITED, Eveleigh (AU)

(21) Appl. No.: 13/364,039

(22) Filed: Feb. 1, 2012

(30) Foreign Application Priority Data
Sep. 20, 2011 (AU) 2011903864

(51) Int. Cl. G06F 9/44

(52) U.S. Cl. 717/130; 717/131

(57) ABSTRACT

A method for tracking and analysing usage of a software product, comprising: (a) collecting data relating to usage of instances of the software product from multiple user devices, wherein the user devices each execute an instance of the software product instrumented to capture the data, and the collected data includes data relating to (i) features of the software product invoked on the user devices, and one or more of: (ii) any errors occurred during the use of the software product and (iii) user feedback indicating satisfaction or dissatisfaction on the software product regardless of whether an error has occurred; and (b) analysing the collected data to determine at least one sequence of the features that is likely to lead to an error and/or a sequence of the features that is likely to lead to user satisfaction or dissatisfaction of the software product for facilitating enhancement of the software product.

### CROSS-REFERENCE TO RELATED APPLICATIONS

The present application claims priority from Australian provisional application No. 2011903864 filed on 20 Sep. 2011, the content of which is incorporated herein by reference.

### TECHNICAL FIELD

This disclosure generally concerns software development and instrumentation, and in particular, computer-implemented method, computer system, user device and computer programs for tracking and analysing usage of a software product.

### BACKGROUND

The development process of a software product generally involves phases of software requirements analysis, software design, implementation and integration, software testing and deployment. Despite pre-deployment testing, errors may still arise in the released product because it may be used in unintended ways and within diverse environments that were not tested. For example, an error may be reported as an exception, which is generated when operations such as divide by zero, incorrect function call, invalid parameter call, overflow or underflow, and the like. Further, there may be aspects of the software design that, while may not cause any errors, have usability issues and hidden design flaws.

### SUMMARY

According to a first aspect, there is provided a computer-implemented method for tracking and analysing usage of a software product, the method comprising:
(a) collecting data relating to usage of multiple instances of the software product from multiple user devices,
wherein the user devices each execute an instance of the software product instrumented to capture the data, and the collected data includes data relating to (i) features of the software product invoked on the user devices, and one or more of: (ii) any errors occurred during the use of the software product and (iii) user feedback indicating satisfaction or dissatisfaction on the software product regardless of whether an error has occurred; and
(b) analysing the collected data to determine at least one sequence of the features that is likely to lead to an error and/or at least one sequence of the features that is likely to lead to user satisfaction or dissatisfaction on the software product for facilitating enhancement to the software product.

The method provides a form of remote telemetry for software developers, user experience designers and product managers who need to understand how their software is being used, what sources of user satisfaction or dissatisfaction that might exist, and the ramifications of their development decisions on the user experience. Further, using crowdsourcing techniques, the method allows users to share their usage data to help improve the usability and design of the software and to facilitate return on investment (ROI) analysis on future development effort, such as by dedicating effort to solve problems that affect most users first. The sequences of features also allow the reproduction of an error to facilitate debugging.

Compared to existing error reporting services, the user feedback may be provided regardless of whether an error has occurred. For example, Microsoft's Windows Error Reporting (WER) is designed to prompt a user to send information about the error of the software product to the software developer. Further, error reports are only generated by the WER when the software fails, but are unable to infer problematic usage patterns where the software has functioned correctly but in a way that is, for example, confusing to the user.

User feedback may comprise a movement-based feedback detected by a spatial displacement sensor on the user device. The user feedback may comprise a touch-based feedback detected by touch screen on the user device. The user feedback may comprise a text-based feedback inputted into the user device. The user feedback may further indicate the level of satisfaction or dissatisfaction on the software product.

Step (b) may further comprise aggregating the usage data to determine possible sequences of features that lead to a particular error or user feedback. The method may further comprise creating a tree data structure to store the possible sequences, the tree data structure having nodes representing features in the possible sequences, and edges representing the number or frequency of occurrence of each feature in the sequences. Even further, the method may further comprise traversing the tree data structure to search for the sequence of features that most likely leads to the error or user feedback based on the number or frequency of occurrence of the features.

The method may further comprise analysing the collected data to determine most popular and/or least popular features of the software product based on the user feedback.

The method may further comprise receiving data relating to the users or user devices and further analysing the received data in step (b) to determine profile of the users or user devices.

The method may further comprise sending data relating to the sequence of features determined in step (b) to a software developer or vendor associated with the software product.

The errors may include programmatic errors and software exceptions.

The features invoked on the user devices may include software functions of the software product.

Each instance of the software product may be instrumented with an application programming interface (API) to capture the data.

According to a second aspect, there is provided a computer program comprising computer-executable instructions that cause a computer system to implement the method according to the first aspect. The computer program may be embodied in a computer-readable medium.

According to a third aspect there is provided a computer system for tracking and analysing usage of a software product, the computer system comprising a server to:
(a) collect data relating to usage of multiple instances of the software product from multiple user devices in communication with the server,
wherein the user devices each execute an instance of the software product instrumented to capture the data, and the collected data includes data relating to (i) features of the software product invoked on the user devices, and one or more of: (ii) any errors occurred during the use of the software product and (iii) user feedback indicating satisfaction or dissatisfaction on the software product regardless of whether an error has occurred; and
(b) analyse the collected data to determine at least one sequence of the features that is likely to lead to an error and/or at least one sequence of the features that is likely to lead to user satisfaction or dissatisfaction on the software product for facilitating enhancement to the software product.

According to a fourth aspect there is provided a method implemented by a user device for tracking and analysing usage of a software product, wherein the user device is instrumented to capture data relating to usage of an instance of the software product and the method comprises:
(a) capturing data relating to usage of the instance of the software product,
wherein the capture data includes data relating to (i) features of the software product invoked on the user devices, and one or more of: (ii) any errors occurred during the use of the software product and (iii) user feedback indicating satisfaction or dissatisfaction on the software product regardless of whether an error has occurred; and
(b) sending the captured data to a server in communication with the user device,
wherein the server is operable to analyse the captured data received from the user device, and from other user devices, to determine at least one sequence of the features that is likely to lead to an error and/or at least one sequence of the features that is likely to lead to satisfaction or dissatisfaction on the software product for facilitating enhancement to the software product.

According to a fifth aspect there is provided a computer program comprising computer-executable instructions that cause a user to implement the method according to the fourth aspect. The computer program may be embodied in a medium readable by the user device.

According to sixth aspect there is provided a user device for tracking and analysing usage of a software product, wherein the user device is instrumented to capture data relating to usage of an instance of the software product, and comprises a processor to:
(a) capture data relating to usage of the instance of the software product,
wherein the capture data includes data relating to (i) features of the software product invoked on the user devices, and one or more of: (ii) any errors occurred during the use of the software product and (iii) user feedback indicating satisfaction or dissatisfaction on the software product regardless of whether an error has occurred; and
(b) send the captured data to a server in communication with the user device,
wherein the server is operable to analyse the captured data received from the user device, and from other user devices, to determine at least one sequence of the features that is likely to lead to an error and/or at least one sequence of the features that is likely to lead to user satisfaction or dissatisfaction on the software product for facilitating enhancement to the software product.

Optional features of the first aspect may also be optional features of the other aspects of the invention.

### BRIEF DESCRIPTION OF DRAWINGS

Non-limiting example(s) of the computer-implemented method, computer program, computer system will now be described with reference to the accompanying drawings, in which:

FIG. 1 is a schematic diagram of an exemplary computer system for tracking and analysing usage of a software product;

FIG. 2 is a schematic diagram of an exemplary user device;

FIG. 3 is a flowchart of an exemplary computer-implemented method for tracking and analysing usage of a software product;

FIG. 4 is a schematic diagram of queues maintained at the server in FIG. 1 for processing log files received from multiple instances of a software product;

FIGS. 5(a), 5(b) and 5(c) illustrate an exemplary queue at different time points;

FIG. 6 is an exemplary tree representing an error or feedback and possible events leading to the error or feedback;

FIG. 7 is an exemplary usage report for a particular error; and

FIG. 8 is an exemplary usage report for a particular software product.

### DETAILED DESCRIPTION

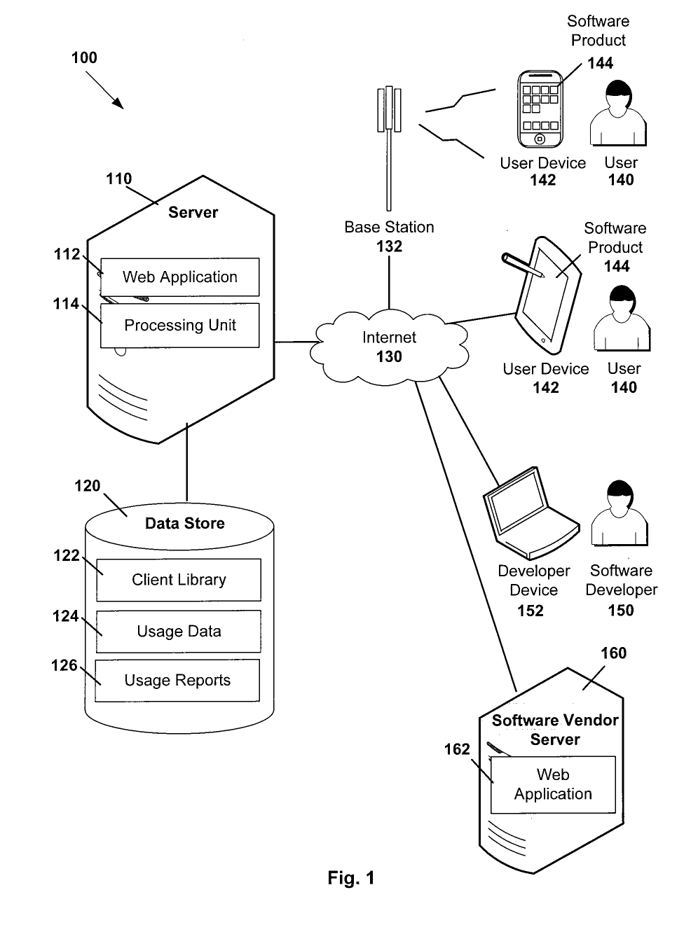

Referring first to FIG. 1, the computer system 100 for tracking and analysing usage of a software product 144 comprises a server 110 in communication with a plurality of end user devices 142 each operated by a user 140, a plurality of software developer devices 152 (one shown for simplicity) each operated by a software developer 150, and a server 160 associated with a software vendor over a communications network 130, 132. Although a single server 110 is shown, it should be understood that the server 110 may comprise more than one server to communicate with the end user devices 142.

As will be explained below, the software product 144 is instrumented with a Usage Monitoring Application Programming Interface (API) to capture data relating to its usage. The software product 144 may be any software-related product, such as application software (also known as an “App”), operating system, embedded software operable to control a device or hardware, plug-in or script. As used herein, the term “instrumented” refers to the programming of the software product 144 to capture data relating to its usage.

The captured usage data includes data relating to:

(i) features of the software product 144 invoked by the users 140,

(ii) errors produced by the software product 144 when the features are invoked, and

(iii) user feedback on the software product 144 as detected by the user devices 142 while the software product 144 is in use.

The usage data captured from multiple instances of the software product 144 is then collected from the user devices 142, aggregated and then analysed by the processing unit 114 at the server 110. Alternatively or additionally, the collected data may be collected by the server 110 via the server 160 associated with the software vendor server. Advantageously, the usage data provides a form of telemetry to allow software developers 150 and vendors 160 to gain better insights into the use of its software products.

A data store 120 accessible by the processing unit 114 stores the collected data 124 and usage reports 126 generated from the collected data 124. The data store 120 also stores a client library 122 accessible by the software developers 150 to instrument the software product 144 during software development.

In one example, the client library 122 is “lightweight”, in the sense that it allows software developers 150 to instrument and mark up events. The events “crowdsourced” from the user devices 142 are sent to the server 110 so they can be aggregated with the events of other users 140. Advantageously, the client library 122 that software developers 150 include in their software product 144 is small, such as in the order of a few hundred lines of code. Further, this allows the server 110 to easily support multiple programming languages, platforms and environments.

User Device 142

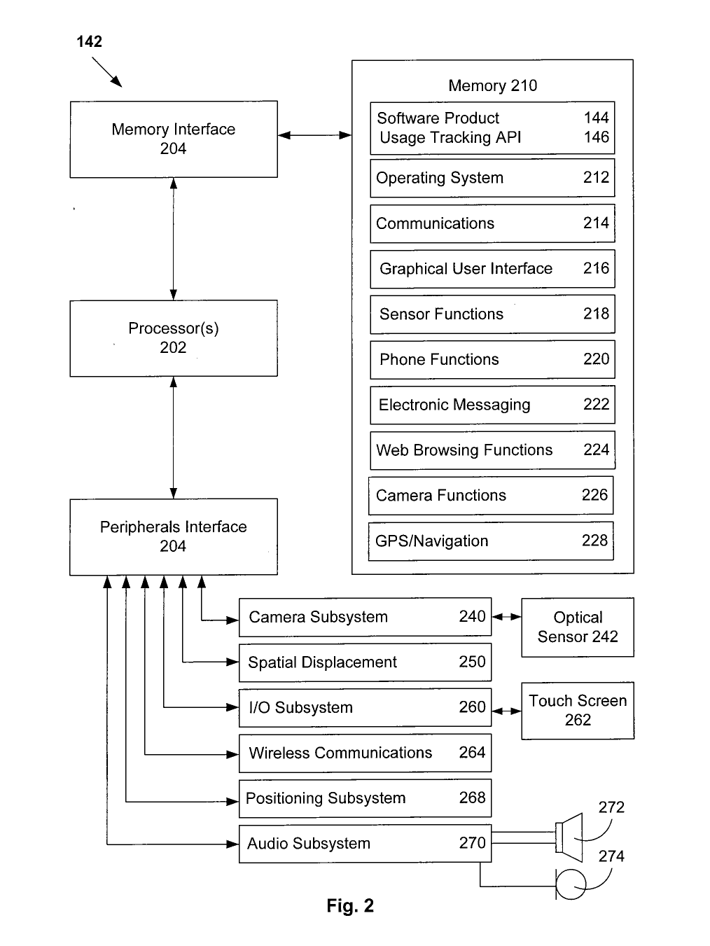

An exemplary implementation of the user device 142 executing an instance of the software product 144 will now be explained with reference to FIG. 2.

In the example in FIG. 1, the user device 142 is exemplified using a mobile phone and tablet computer, but any other suitable devices such as desktop computer, laptop and personal digital assistant (PDA) may be used. The user device 142 comprises one or more processors (or central processing units) 202 in communication with a memory interface 204 coupled to a memory device 210, and a peripherals interface 206.

The memory device 210, which may include random access memory and/or non-volatile memory, stores an instance of the software application 144 instrumented with the Usage Tracking API 146; an operating system 212; and executable instructions to perform communications functions 214, graphical user interface processing 216, sensor functions 218, phone-related functions 220, electronic messaging functions 222, web browsing functions 224, camera functions 226, and GPS or navigation functions 228.

Sensors, devices and subsystems can be coupled to the peripherals interface 204 to facilitate various functionalities, such as the following.
Camera subsystem 240 is coupled to an optical sensor 242, such as a charged coupled device (CCD) or a complementary metal-oxide semiconductor (CMOS) optical sensor, to facilitate camera functions.
Spatial displacement sensor 250 is used to detect movement of the user device 142. For example, the spatial displacement sensor 250 comprises one or more multi-axis accelerometers to detect acceleration in three directions, i.e. the x or left/right direction, the y or up/down direction and the z or forward/backward direction. As such, any rotational movement, tilt, orientation and angular displacement can be detected.
Input/Output (I/O) subsystem 260 is coupled to a touch screen 262 sensitive to haptic and/or tactile contact via a user, and/or other input devices such as buttons. The touch screen may also comprise a multi-touch sensitive display that can, for example, detect and process a number of touch points simultaneously. Other touch-sensitive display technologies may also be used, such as display in which contact is made using a stylus.
Wireless communications subsystem 264 allows wireless communications over a network employing suitable technologies such as GPRS, WCDMA, OFDMA, WiFi or WiMax and Long-Term Evolution (LTE).
Positioning subsystem 268 collects location information of the device by employing any suitable positioning technology such as GPS Assisted-GPS (aGPS). GPS generally uses signals from satellites alone, while aGPS additionally uses signals from base stations or wireless access points in poor signals condition. Positioning system 268 may be integral with the mobile device or provided by a separate GPS-enabled device coupled to the mobile device.
Audio subsystem 270 can be coupled to a speaker 272 and microphone 274 to facilitate voice-enabled functions such as telephony functions

Software Instrumentation 310

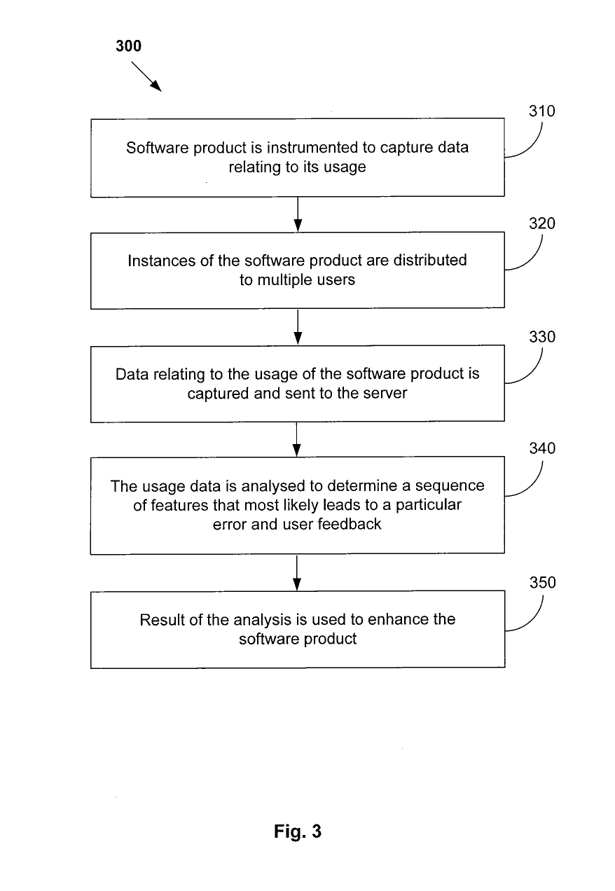

During the software implementation phase, the software product 144 is instrumented with the Usage Tracking API 146 to capture data relating to the usage of the software product; see step 310 in FIG. 3.

The Usage Tracking API serves as an interface between the software product 144 and the web application 112 at the server 110. The Usage Tracking API is defined in the client library 122 that is accessible by the software developers 150 from the data store 120 when implementing the software product 144. The API defines a set of request and response messages that can be used to instrument the software product 144 to facilitate the collection and aggregation of the usage data by the server 110.

In one example, the API for an iPhone application 144 may include the following initialisation code that is called when the application 144 is executed:
[UserMetrix configure:YOUR_PROJECT_ID canSendLogs:true];

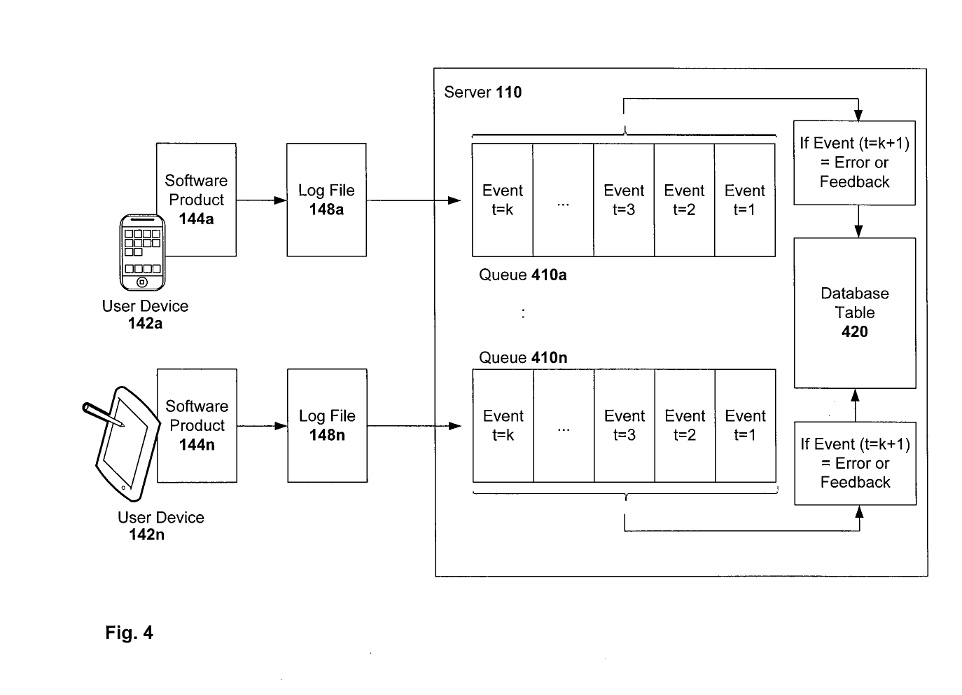

In this case, “UserMetrix” identifies the server 110, and “YOUR_PROJECT_ID” identifies the application 144. The code configures the application so that it can capture usage data in log files 148 and send the log files 148; see also FIG. 4.

The application 144 is then instrumented with the following calls to capture various usage data, where “source:UM_LOG_SOURCE” identifies the log file 148 in which the captured usage data is stored:
(i) features of the software product 144 invoked by the users 140,
   [UserMetrix event:@“myAction” source:UM_LOG_SOURCE];
(ii) errors produced by the software product 144 when the features are invoked,
   [UserMetrix errorWithMessage:@“first error message” source:UM_LOG_SOURCE];
(iii) user feedback on the software product 144 as detected by the user devices 142
   [UserMetrix feedback:@“user feedback” source:UM_LOG_SOURCE];

The application 144 is also instrumented with the following “shutdown” code that packages and sends the captured usage data (in log files 148) to the server 110:
[UserMetrix shutdown];

Note that the application 144 can also be instrumented to send captured usage data to the server 110 in real time, instead of in batches or waiting until the application 144 shuts down.

The above API method calls are defined in the client library 122 accessible by the software developers 150. The client library 122 may include clients for different technology platforms, such as Android, iPhone, iPad, Java and C/C++. The availability of the clients makes it easy for software developers 150 working on a particular platform to send captured usage data to the server 110.

The instrumentation process may also be automated or semi-automated, using scripts accessible by the software developers 150 from the server 110 and then further tailored by the software developers 150 for a particular software product.

In one example, the usage data captured by the software product 144 are in the form of “events” definable by the software developer 150 to capture the following:
(a) Features of the software product 144 that have been invoked on the user devices 142, such as software functions or classes invoked and their parameters. For example, the functions or classes may be invoked when a “save” or “open file” button is pressed; when a recipe or ingredient is added, saved, edited, deleted in a particular application; when a cell in a spread sheet is created, edited or deleted; and when a picture is tagged or edited. The idea here is to capture when the user has expressed the intent of performing some action or desired goal (save, open, create, edit, delete, tag), and some interaction with the software product 144 that expresses the intent or action.
(b) Errors occurred during the execution of the software product 144, such as programmatic errors, faults and exceptions. Examples of errors include the inability to open a file, divide by zero error, invalid parameter, incorrect function call, failed pre-condition and/or post-condition tests for a method, array out of bounds (when attempting to access an index of an array that is not valid), stack overflow (when stack size is exceeded), null pointer (when attempting to do something on invalid or null memory), and the like. The errors may be due to the source code or design of the software product 144.
(c) User feedback that can be provided by users 140 at any time during the use of the software product 144, regardless of whether an error has occurred.

The user feedback may include both positive and negative feedback. For example, the software product 144 may have performed as intended but the user 140 can provide a negative feedback to reflect frustrations or dissatisfactions towards the usability of the software product 144. If a user 140 is satisfied or impressed with a particular feature, a positive feedback may be provided instead.

The user feedback may be movement-based, such as movement of the user device 142 as detected by the spatial displacement sensor 250 of the user device 142. For example, a negative feedback may be provided by shaking the user device 142 at least twice. Once the movement is detected, a “negative feedback” event is captured by the Usage Tracking API 146 and recorded in a log file.

The user feedback may also be touch-based, as detected by the touch display screen 262 on the user device 142. A positive feedback may be provided by tickling, tapping or pinching the touch display screen 262. In this case, a “positive feedback” event is captured by Usage Tracking API 146 and recorded in a log file.

The user feedback may also be text-based. For example, when movement-based and touch-based feedback is not suitable for computer desktop applications or websites, a different mechanism can be integrated with the applications or websites to gather user feedback at any time, rather than just when an error occurs. In this case, the mechanism may be an input field at the bottom of the screen that operates independently from the software product 144 such that feedback can still be entered despite the software product 144 failing.

The user feedback is based on the users' 140 opinions and experiences of the software product. For example, the feedback may be “I couldn't add a cell” from a user 140 who was unable to add a cell to a spreadsheet. This might be due to the user 140 using the wrong part or feature of the software product 144 to add spreadsheet cells. In another example, the feedback may be “I can't delete this recipe” from a user who was unable to remove a recipe from a recipe listing. This might be due to the software product 144 (in this case, a cookbook software) being in a locked or view only mode. The feedback facilitates enhancement of the software product 144 to improve its usability.

Software Usage Tracking

During the software deployment phase, various instances of the software product 144 are distributed to the users 140 for execution on their user devices 142; see step 320 in FIG. 3. For example, the software product 144 may be downloaded onto the user devices 142 from the server 160 associated with the software vendor or any third party server.

Once the users 140 have given consent to the automatic capture of usage data, the usage, error and feedback events will be captured and sent to the server 110 for analysis; see step 330 in FIG. 3.

For each event, event properties such as its type (usage, error or feedback), time occurred, source (feature or software function invoked by the user 140) and message (an auto-generated text-based description) are recorded in a log file and sent to the server 110. The ‘source’ defines the location in the software product 144 that raises the error or invokes the feature. For example, feature “save file” might be stored within the source file “save.java”.

For example, every time the user 140 invokes a feature of the software product 144, a “usage event” is captured by the Usage Tracking API 146 as follows:

Usage Events

| | |
|---|---|
| 1 | type: usage |
| 2 | date: 20110828 |
| 3 | id: 101 |
| 4 | time: 10230 |
| 5 | source: class com.example.jclient.controllers.DeleteCellC |
| 6 | message: setting spreadsheet deleting cells |
| 7 | type: usage |
| 8 | date: 20110828 |
| 9 | id: 102 |
| 10 | time: 13334 |
| 11 | source: class com.example.jclient.class |
| 12 | message: setting spreadsheet layout:StrongTemporal |

Any errors or exceptions are captured as an “error event”, an example of which is shown below.

Error Event

| | |
|---|---|
| 1 | type: error |
| 2 | id: 303 |
| 3 | time: 16009 |
| 4 | date: 20110828 |
| 5 | source: class org.openshapa.controllers.DeleteColumnC |
| 6 | message: Unable to delete cell by ID |
| 7 | stack: |
| 8 | - class: org.openshapa.models.db.DataCell |
| 9 | line: 1992 |
| 10 | method: deregisterExternalListener |
| 11 | - class: org.openshapa.models.db.Database |
| 12 | line: 2345 |
| 13 | method: deregisterDataCellListener |

Lines 7 to 11 store a call stack associated with the error. The call stack is the location in source code that caused the error. The call stack provides a map from the start of the application to the exception, such as:
main start point of program
called methodA
called methodB
called methodC which crashed.

When the software product 144 performs a feature or function that frustrates the user 140, the user 140 can provide a negative feedback that is captured as a “negative feedback event”.

Negative Feedback Event

| | |
|---|---|
| 1 | type: negativefeedback |
| 2 | id: 119 |
| 3 | time: 18099 |
| 4 | date: 20110828 |
| 5 | source: class com.example.jclient.class |
| 6 | message: can't figure this thing out |

On the other hand, if the user 140 is impressed with a particular feature or processing speed of the software product 144, a “positive feedback event” is captured.

Positive Feedback Event

| | |
|---|---|
| 1 | type: positivefeedback |
| 2 | id: 051 |
| 3 | time: 11011 |
| 4 | date: 20110828 |
| 5 | source: class com.example.jclient.class |
| 6 | message: this solved my problem |

For the exemplary feedback events, the ‘source’ is identified by the source of the last received usage event. Referring to the usage events defined earlier in the document, the last received usage event is “setting spreadsheet layout:StrongTemporal”. The corresponding ‘source’ is ‘class com.example.jclient.class’, which is also recorded as the ‘source’ of the user feedback that follows this last received usage event.

The feedback events may also record the level of satisfaction or dissatisfaction of the user. For example, the level may be measured from the magnitude of the spatial displacement, force (amount of effort exerted), and speed detected on the user device 142. For text-based user feedback, a rating between zero to five may be provided to measure the level of satisfaction (five stars) or dissatisfaction (no star).

In the above exemplary events, the unique ‘id’ of an event is calculated as an MD5 checksum of the content of the events, such as ‘source’, ‘message’ and, if available, ‘call stack’. The MD5 checksum functions as a unique digital fingerprint of the event. In other cases, ids that are generated sequentially, such as based on the time at which the event is created, may be used.

The usage, error and feedback events captured by the software product 144 are then stored in one or more log files 148, which is then sent to the server 110 for further analysis. The log file(s) 148 also include information on the instance of the software product that captures the usage data, as follows:

1 v: 1
2 system:
3 id: 4a48833b-f5b9-4dc1-827b-55a3ef1fc779
4 os: Mac OS X - 10.6.8
5 start: 2011-09-09T13:13:27.451+1000
6 meta:
7 - build: v:1.11(Beta):null

The above identifies the version (‘v’) and build (‘build’) of the software product 144, the particular instance of the software product (‘id’), the operating system on which it is executed (‘os’), and start time of its execution (‘start’).

The log file(s) 148 are sent to the server 110 when the software product 144 is terminated or closed. If successfully transmitted, the log file(s) 148 are deleted from the memory 210 on the user device 142. Otherwise, if the transmission fails, the software product 144 is instrumented to resend the log file(s) 148 stored in the memory before creating a new log file 148. The failed transmission may be due to the software product 144 crashing unexpectedly or due to network problems. As previously explained, the log file(s) 148 may also be sent to the server 110 in real time or periodically instead.

Software Usage Analysis

The usage data in the log files 146 sent by the user devices 142 are collected and analysed by the server 110 to determine, inter alia, a sequence of features that most likely leads to a particular error and user feedback; see step 340 in FIG. 3.

More specifically, as shown in FIG. 4, the processing unit 114 at the server 110 maintains a queue 410a (410n) for each log file 148a (148n) received from an instance of the software product 144a (144n). The queue 410a (410n) is of a predetermined size k to store up to k events included in the log file 148a.

Every time an error or feedback event is encountered, the k events stored in the queue 410a (410n) are saved into a database table 420. The k events represent a possible sequence of features invoked by the user that lead to that particular error or feedback.

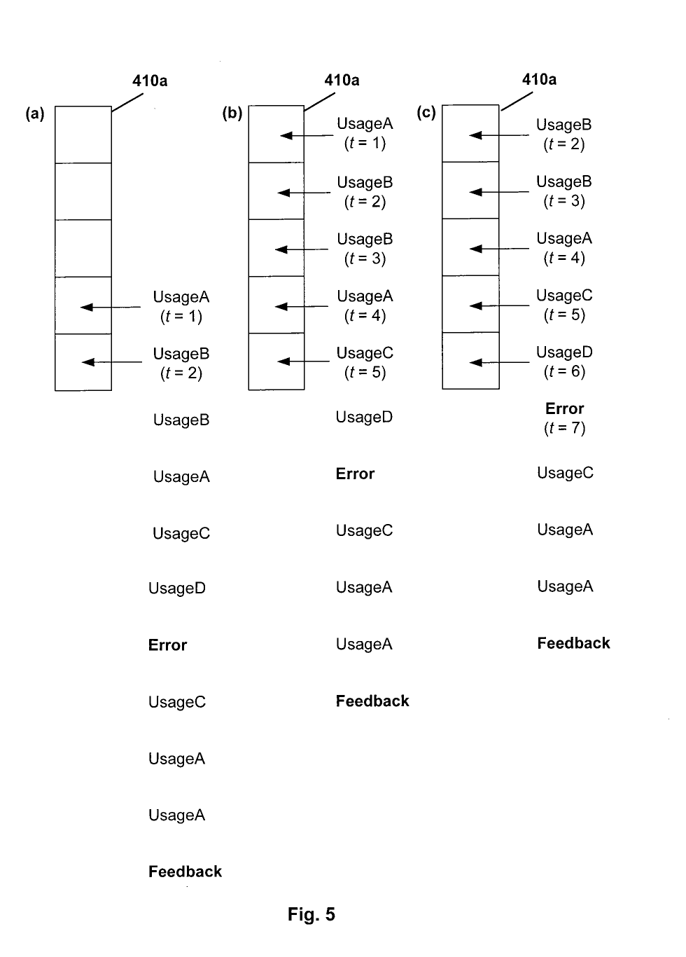

Referring also to FIG. 5, the events included in the log file 148a are stored in the queue 410a in order of occurrence or time of arrival. In this case, k=5 which means at most 5 events are stored in the queue 410a. As shown in FIG. 5(a) and FIG. 5(b), event ‘UsageA’ is stored in the queue 410a at time t=1, followed by events ‘UsageB’, ‘UsageB’, ‘UsageA’ and ‘UsageC’ at times t=2, 3, 4 and 5. At time t=6 in FIG. 5(c), the event stored at time t=1, ‘UsageA’, is displaced by event ‘UsageD’.

The first-in-first-out (FIFO) queuing continues until an error or feedback event is encountered, for example, at t=7. In this case, the k=5 events stored in the queue 410a, i.e. ‘UsageB’, ‘UsageB’, ‘UsageA’, ‘UsageC’ and ‘UsageD’, are copied into a new entry created in the database table 420; see also FIG. 4. The new entry comprises the id of the error or feedback event, description of the error or feedback event (label, time and date of occurrence), and the k=5 usage events leading to the error or feedback.

The above steps are repeated for all the events collected from all users 140 of instances of the software product 144. After a while, the database table 420 comprises the following entries for different types of errors and user feedback:

Error Table (k = 5)

| Id | Error | Event 1 | Event 2 | Event 3 | Event 4 | Event 5 |
|---|---|---|---|---|---|---|
| 1 | Error1 | UsageB | UsageB | UsageA | UsageC | UsageD |
| 1 | Error1 | UsageA | UsageD | UsageA | UsageC | UsageD |
| . | . | . | . | . | . | . |
| . | . | . | . | . | . | . |
| . | . | . | . | . | . | . |
| 2 | Error2 | UsageD | UsageD | UsageC | UsageA | UsageB |

Feedback Table (k = 5)

| Id | Feedback | Event 1 | Event 2 | Event 3 | Event 4 | Event 5 |
|---|---|---|---|---|---|---|
| 1 | Feedback1 | UsageB | UsageB | UsageA | UsageC | UsageD |
| 2 | Feedback2 | UsageA | UsageD | UsageA | UsageC | UsageD |
| . | . | . | . | . | . | . |
| . | . | . | . | . | . | . |
| . | . | . | . | . | . | . |
| 2 | Feedback2 | UsageD | UsageD | UsageC | UsageA | UsageB |

Although not shown, the tables above may also include data relating to users 140 or user devices 142 that generated the log files 146, such as the operating system and device maker.

Entries in the database table 420 forms a “search space” for the processing unit 114 to determine one or more sequences of features or usage events that are likely to lead to a particular error or feedback. Since the feedback may be positive or negative, the sequence of features identified help software developers to identify features that are liked by the users 140 or otherwise.

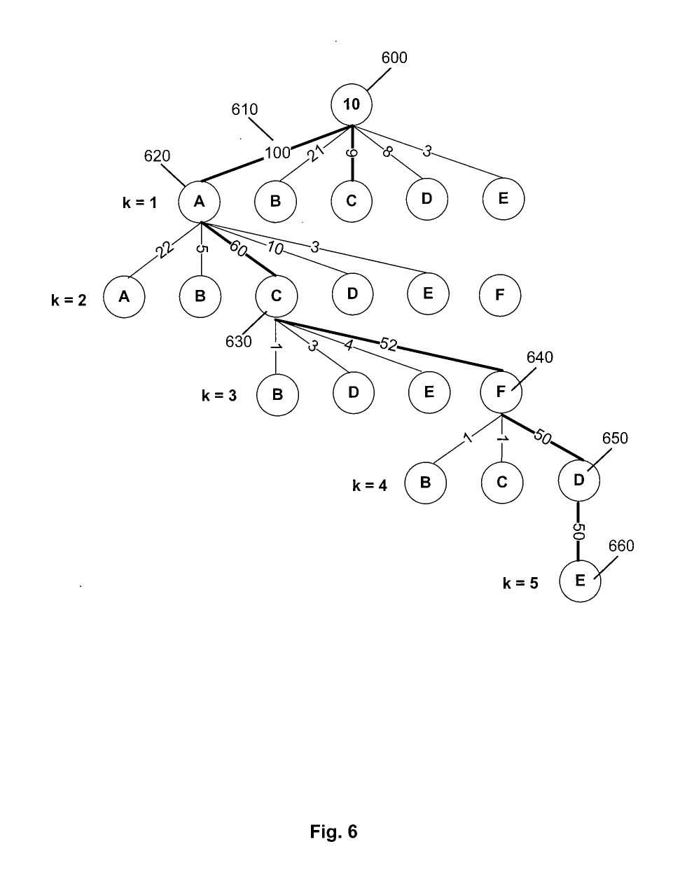

Referring also to FIG. 6, a search can be performed on a particular error with id ‘10’ to determine the most probable sequence of features or usage events leading to the error. In this example, the search space is represented by a tree data structure having a root node 610 representing the error with id ‘10’ and multiple paths of k nodes each representing a possible sequence of k events leading to the error.

The value of each edge represents the number of occurrences of a node. For example, edge 610 has a value of ‘100’ which is the number of usage events ‘A’ that lead to the error 610, as collected from various instances of the software product (144a . . . 144n). It should be noted that the frequency of the node may be used instead, such as 100/(100+21+6+8+3)=0.72 instead of 100.

Any suitable path-finding and tree traversal algorithms, such as A*, breadth-first, depth-first, depth-limited and iterative deepening depth-first search. In the example in FIG. 6, an A* algorithm is used by the processing unit 114 to find the most probable path or sequence of events that lead to the software error 610. Starting at the root node 610, the processing unit 114 proceeds to explore the edge with the highest value, in this case edge 610 with a value of ‘100’ that leads to usage event ‘A’. At the next level, the edge leading to the node 630 with usage event ‘C’ is explored because it has occurred 60 times compared to other edges, i.e. 22 times of node ‘A’, 5 times of node ‘B’, 10 times of node ‘D’ and 3 times of node ‘E’.

The search continues to the next levels, where nodes ‘F’ (640), ‘D’ (650) and ‘E’ (660) are explored with the same greedy algorithm. Since k=5 events are stored in the database table 420, the tree traversal algorithm only operates to the maximum depth of 5 from the root node 600. As such, the sequence of features that most likely leads to the error therefore comprises nodes ‘E’ (660), ‘D’ (650), ‘F’ (640), ‘C’ (630) and ‘A’ (620). This path represents most likely steps that can be used by the software developers 160 to reproduce the error for debugging purposes.

The tree illustrated in FIG. 6 may also represent a positive or negative feedback, and the different possible sequences of usage events leading to the feedback. Using a similar search algorithm, the sequence of usage events leading to the feedback can be determined.

Further, the processing unit 114 can also derive the following metrics from the database table 420:
The number of users 140 (as represented by the number of instances of the software product 144) affected by the error;
The profile of the operating system used by the users 140 (as represented by the number of instances of the software product 144) affected by the error;
Trend of the error as represented by the number of errors against the date of occurrence; and
The profile of a call stack associated with the error.

For the software product 144, the processing unit 114 is operable to derive the following metrics from the analysis performed:
Most common errors;
Most popular features as determined from the positive feedback;
Least popular features as determined from the negative feedback;
Average level of satisfaction or dissatisfaction;
Trend analysis of the errors or feedback;
Profile of users who use the software product 144 once (and never again) to determine barriers facing new users 140;
Profile of features to indicate how a particular feature is used and edge cases that trap or frustrates users; and
Operating system of users 140 of the most common errors.

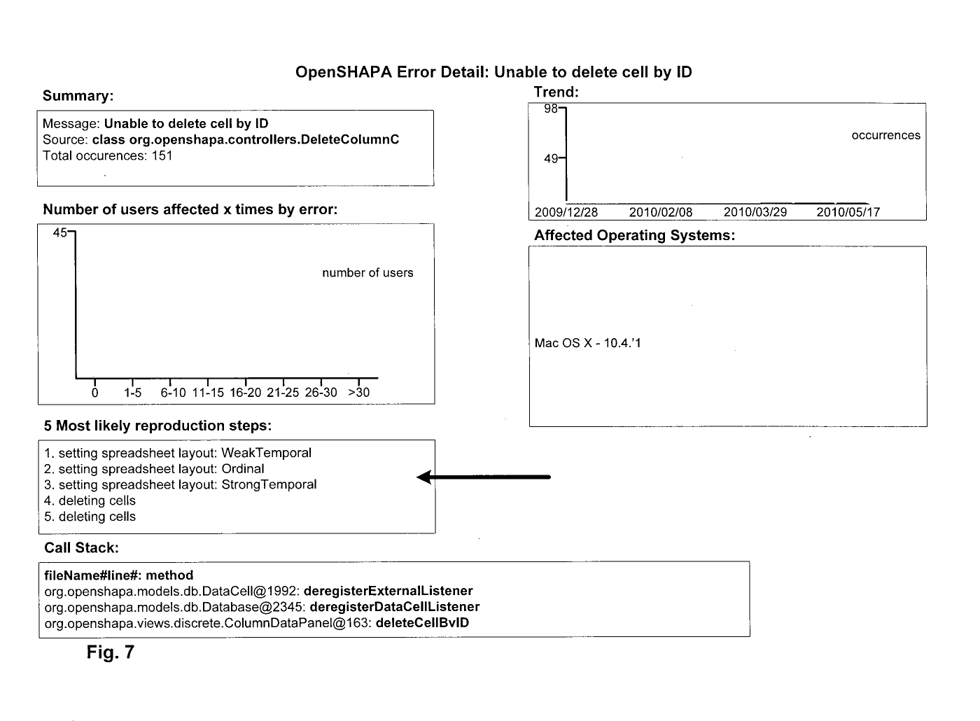

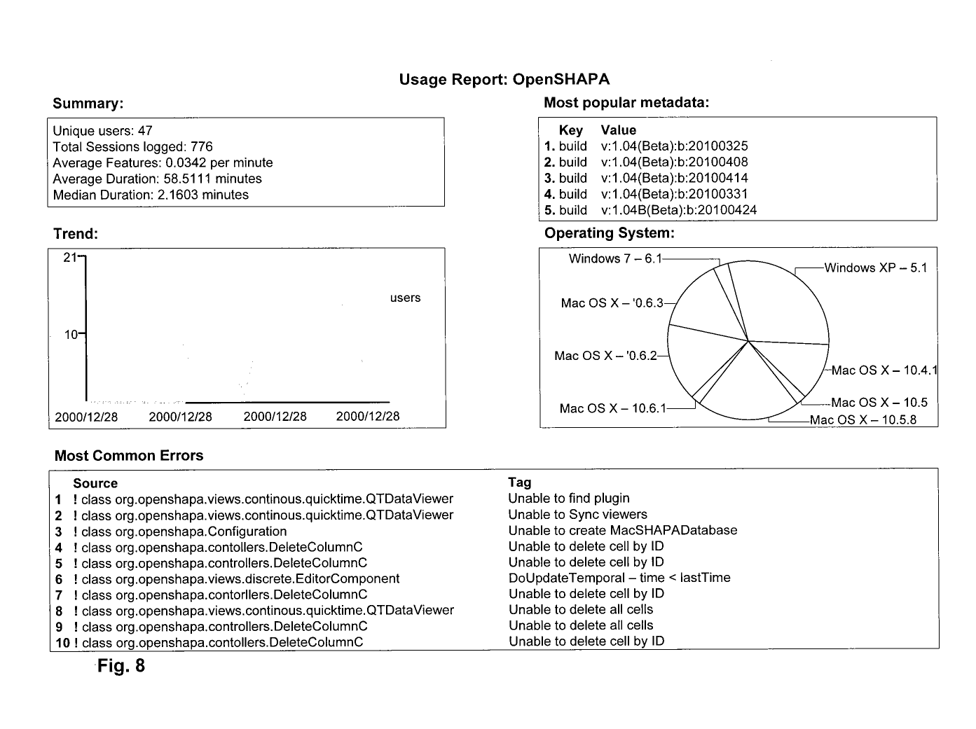

Usage reports with the calculated metrics are shown in FIG. 7 and FIG. 8 respectively.

It will be appreciated that location-based usage reports may also be created, if the software product 144 is further instrumented to collect GPS information of the user devices 142. In particular, this provides software developers 150 with an insight into how the software product 144 is used differently in different locations, and the different features that may attract negative or positive feedback from users of a particular location.

Closed-Loop Software Development

The result of the analysis in step 340 is then used to enhance the software product 144; see step 350 in FIG. 3. The usage reports 146 shown in FIG. 7 and FIG. 8 are stored in the data store 120 and made available to the software developers 146 at the server 110.

For example, the sequence of features ‘E’ (660), ‘D’ (650), ‘F’ (640), ‘C’ (630) and ‘A’ (620) in FIG. 6 allows the error ‘10’ (600) to be reproduced by a software developer 160 to diagnose and repair the error. Similarly, any information on the popularity of a feature (or otherwise) helps steer future development effort to enhance the software product 144.

Outputs of the analysis in step 340 can also be fed into the software development lifecycle by adding the ability to tie into existing bug tracking packages, thereby making it easier to create new bugs and development work items from data collected by the server 110.

The result of the analysis in step 340 may also be used to automatically create test cases that can be used by software developers 150 to quickly resolve software issues and to verify that, for example, software fixes are not broken in subsequent software releases.

It should also be understood that, unless specifically stated otherwise as apparent from the following discussion, it is appreciated that throughout the description, discussions utilizing terms such as “receiving”, “processing”, “retrieving”, “selecting”, “collecting”, “analysing”, “determining”, “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices. Unless the context clearly requires otherwise, words using singular or plural number also include the plural or singular number respectively.

It should also be understood that the techniques described might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media (e.g. copper wire, coaxial cable, fibre optic media). Exemplary carrier waves may take the form of electrical, electromagnetic or optical signals conveying digital data streams along a local network or a publically accessible network such as the Internet.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. A computer-implemented method for tracking and analysing usage of a software product, the method comprising:
(a) collecting data relating to usage of multiple instances of the software product from multiple user devices,
wherein the user devices each execute an instance of the software product instrumented to capture the data, and the collected data includes data relating to (i) features of the software product invoked on the user devices, and one or more of: (ii) any errors occurred during the use of the software product and (iii) user feedback indicating satisfaction or dissatisfaction on the software product regardless of whether an error has occurred; and
(b) analysing the collected data to determine at least one sequence of the features that is likely to lead to an error and/or at least one sequence of the features that is likely to lead to user satisfaction or dissatisfaction on the software product for facilitating enhancement to the software product.

2. The method of claim 1, wherein the user feedback comprises a movement-based feedback detected by a spatial displacement sensor on the user device.

3. The method of claim 1, wherein the user feedback comprises a touch-based feedback detected by touch screen on the user device.

4. The method of claim 1, wherein the user feedback comprises a text-based feedback inputted into the user device.

5. The method of claim 1, wherein the user feedback further indicates the level of satisfaction or dissatisfaction on the software product.

6. The method of claim 1, wherein step (b) comprises aggregating the usage data to determine possible sequences of features that lead to a particular error or user feedback.

7. The method of claim 6, further comprising creating a tree data structure to store the possible sequences, the tree data structure having nodes representing features in the possible sequences, and edges representing the number or frequency of occurrence of each feature in the sequences.

8. The method of claim 7, further comprising traversing the tree data structure to search for the sequence of features that most likely leads to the error or user feedback based on the number or frequency of occurrence of the features.

9. The method of claim 1, further comprising analysing the collected data to determine most popular and/or least popular features of the software product based on the user feedback.

10. The method of claim 1, further comprising receiving data relating to the users or user devices and further analysing the received data in step (b) to determine profile of the users or user devices.

11. The method of claim 1, further comprising sending data relating to the sequence of features determined in step (b) to a software developer or vendor associated with the software product.

12. The method of claim 1, wherein the errors include programmatic errors and software exceptions.

13. The method of claim 1, wherein the features invoked on the user devices include software functions of the software product.

14. The method of claim 1, wherein each instance of the software product is instrumented with an application programming interface (API) to capture the data.

15. A computer program comprising computer-executable instructions recorded on a computer-readable medium, the computer program being operable to cause a computer system to implement a method for tracking and analysing usage of a software product, wherein the method comprises:
(a) collecting data relating to usage of multiple instances of the software product from multiple user devices,
wherein the user devices each execute an instance of the software product instrumented to capture the data, and the collected data includes data relating to (i) features of the software product invoked on the user devices, and one or more of: (ii) any errors occurred during the use of the software product and (iii) user feedback indicating satisfaction or dissatisfaction on the software product regardless of whether an error has occurred; and
(b) analysing the collected data to determine at least one sequence of the features that is likely to lead to an error and/or at least one sequence of the features that is likely to lead to user satisfaction or dissatisfaction on the software product for facilitating enhancement to the software product.

16. A computer system for tracking and analysing usage of a software product, the computer system comprising a server to:
(a) collect data relating to usage of multiple instances of the software product from multiple user devices in communication with the server,
wherein the user devices each execute an instance of the software product instrumented to capture the data, and the collected data includes data relating to (i) features of the software product invoked on the user devices, and one or more of: (ii) any errors occurred during the use of the software product and (iii) user feedback indicating satisfaction or dissatisfaction on the software product regardless of whether an error has occurred; and
(b) analyse the collected data to determine at least one sequence of the features that is likely to lead to an error and/or at least one sequence of the features that is likely to lead to user satisfaction or dissatisfaction on the software product for facilitating enhancement to the software product.

17. A method implemented by a user device for tracking and analysing usage of a software product, wherein the user device is instrumented to capture data relating to usage of an instance of the software product and the method comprises:
(a) capturing data relating to usage of the instance of the software product,
wherein the capture data includes data relating to (i) features of the software product invoked on the user devices, and one or more of: (ii) any errors occurred during the use of the software product and (iii) user feedback indicating satisfaction or dissatisfaction on the software product regardless of whether an error has occurred; and
(b) sending the captured data to a server in communication with the user device,
wherein the server is operable to analyse the captured data received from the user device, and from other user devices, to determine at least one sequence of the features that is likely to lead to an error and/or at least one sequence of the features that is likely to lead to satisfaction or dissatisfaction on the software product for facilitating enhancement to the software product.

18. A computer program comprising computer-executable instructions recorded on a computer-readable medium on a user device, the computer program being operable to cause the user device to implement a method for tracking and analysing usage of a software product, wherein the user device is instrumented to capture data relating to usage of an instance of the software product and the method comprises
(a) capturing data relating to usage of the instance of the software product,
wherein the capture data includes data relating to (i) features of the software product invoked on the user devices, and one or more of: (ii) any errors occurred during the use of the software product and (iii) user feedback indicating satisfaction or dissatisfaction on the software product regardless of whether an error has occurred; and
(b) sending the captured data to a server in communication with the user device,
wherein the server is operable to analyse the captured data received from the user device, and from other user devices, to determine at least one sequence of the features that is likely to lead to an error and/or at least one sequence of the features that is likely to lead to satisfaction or dissatisfaction on the software product for facilitating enhancement to the software product.

19. A user device for tracking and analysing usage of a software product, wherein the user device is instrumented to capture data relating to usage of an instance of the software product, and comprises a processor to:
(a) capture data relating to usage of the instance of the software product,
wherein the capture data includes data relating to (i) features of the software product invoked on the user devices, and one or more of: (ii) any errors occurred during the use of the software product and (iii) user feedback indicating satisfaction or dissatisfaction on the software product regardless of whether an error has occurred; and
(b) send the captured data to a server in communication with the user device,
wherein the server is operable to analyse the captured data received from the user device, and from other user devices, to determine at least one sequence of the features that is likely to lead to an error and/or at least one sequence of the features that is likely to lead to user satisfaction or dissatisfaction on the software product for facilitating enhancement to the software product.
